(19) United States
(12) Patent Application Publication
(10) Pub. No.: US 2005/0021376 A1
(43) Pub. Date: Jan. 27, 2005

(54) System for accessing patient information

(76) Inventors: John R. Zaleski, West Brandywine, PA (US); Brian Lawrence, Perkasie, PA (US)

Correspondence Address: Alexander J. Burke;Intellectual Property Department 5th Floor, 170 Wood Avenue South, Iselin, NJ, 08830, US

(21) Appl. No.: 10/785,305

(22) Filed: Feb. 24, 2004

Related U.S. Application Data
(60) Provisional application No. 60/454,278, filed on Mar. 13, 2003.

(51) Int. Cl. G06F 17/60

(52) U.S. Cl. 705/3

(57) ABSTRACT

Certain exemplary embodiments provide a system for accessing patient medical information in a network. The network comprises a plurality of servers. Certain exemplary embodiments of the network further comprise a repository including patient identifiers and associated server identifiers for use in identifying one or more servers that store medical information associated with a particular patient. To respond to a received command or request to display a particular patient's medical information, certain exemplary embodiments of the network comprise a search processor for initiating a search of the repository to locate a particular server identifier associated with an identifier of a particular patient. To respond to a user command, certain exemplary embodiments of the network comprise an interface processor for generating a uniform resource locator (URL) address incorporating a located particular server identifier in a data field and for initiating a request to access stored medical information of a particular patient at a generated URL address hosted by a server.

### CROSS-REFERENCE TO RELATED APPLICATIONS

This application claims priority to pending provisional application Ser. No. 60/454,278 (Applicant Docket No. 03P03690US), filed Mar. 13, 2003.

### BACKGROUND

Known products provide a Web viewer for patient vitals data. To display a particular patient's vitals data via the Web viewer, a user typically needs to provide a series of identifiers, including user ID, user password, name of the patient, the patient identification code, the server and/or location where the patient vitals data resides, etc. However, a user often will not know one or more of the required identifiers for accessing such vitals data as such information is normally at least partially maintained within the clinical environment at the point of care. Furthermore, the temporal currency of such data may be in question. In certain known products, user-obtained data and/or medical records do not accurately reflect real-time patient information.

### SUMMARY

Certain exemplary embodiments provide a system for accessing patient medical information in a network. The network comprises a plurality of servers. Certain exemplary embodiments of the network further comprise a repository including patient identifiers and associated server identifiers for use in identifying one or more servers that store medical information associated with a particular patient. To respond to a received command or request to display a particular patient's medical information, certain exemplary embodiments of the network comprise a search processor for initiating a search of the repository to locate a particular server identifier associated with an identifier of a particular patient. To respond to a user command, certain exemplary embodiments of the network comprise an interface processor for generating a uniform resource locator (URL) address incorporating a located particular server identifier in a data field and for initiating a request to access stored medical information of a particular patient at a generated URL address hosted by a server.

### BRIEF DESCRIPTION OF THE DRAWINGS

A wide array of potential embodiments can be better understood through the following detailed description and the accompanying drawings in which:

FIG. 1 is an exemplary embodiment of a system for accessing patient information;

FIG. 2 is a block diagram of an exemplary embodiment of an information device for accessing patient information;

FIG. 3 is an exemplary embodiment of a user interface supporting an operation associated with a system for accessing patient information;

FIG. 4 is an exemplary embodiment of a user interface supporting an operation associated with a system for accessing patient information;

FIG. 5 is an exemplary embodiment of a user interface supporting an operation associated with a system for accessing patient information;

FIG. 6 is an exemplary embodiment of a user interface supporting an operation associated with a system for accessing patient information;

FIG. 7 is a flow chart of an exemplary embodiment of a method for a system for accessing patient information; and

FIG. 8 is a flow chart of an exemplary embodiment of a method for a system for accessing patient information.

### DEFINITIONS

When the following terms are used herein, the accompanying definitions apply:
Database—one or more structured sets of persistent data, usually associated with software to update and query the data. A simple database might be a single file containing many records, each of which is structured using the same set of fields. A database can comprise a map wherein various identifiers are organized according to various factors, such as identity, physical location, location on a network, function, etc.
Function link—a link on a page that allows a user to access a particular function by activating the function link through an action such as a keyboard stroke or mouse click. Activation of a function link can occur through a “single action”, which as used herein refers to any single act that can activate a function, such as a mouse click, a mouseover, a keyboard stroke, a pen stroke, a finger stroke or signal, a voice signal, staring at a predetermined screen location for a predetermined time, and/or any equivalents thereof.
Identifier—a group of symbols that are unique to a particular entity, activity, and/or document. An identifier can be, for example, a medical record number. An identifier can be human and/or machine readable, such as for example, a number, an alphanumeric string, a bar code, an RFID, etc.
Patient identifier—an identifier for a particular patient of a healthcare organization. A patient identifier might be a social security number, taxpayer ID number, national ID number, Medicare number, Medicaid number, medical insurance ID number, medical record number, etc.
Server identifier—an identifier for a particular server to which one or more patient monitoring devices are linked.
User identifier—an identifier for a particular user of a device and/or system described herein.
Information device—a device capable of processing information, such as any general purpose and/or special purpose computer, such as a personal computer, workstation, server, minicomputer, mainframe, supercomputer, computer terminal, laptop, phone, and/or any equivalents thereof, etc.
Interface—a boundary across which two independent systems meet and act on or communicate with each other. To connect with or interact with by means of an interface.
Machine-readable media—a memory readable by an information device.
Memory—a device capable of storing analog or digital information, for example, a non-volatile memory, volatile memory, Random Access Memory, RAM, Read Only Memory, ROM, flash memory, magnetic media, a hard disk, a floppy disk, a magnetic tape, an optical media, an optical disk, a compact disk, a CD, a digital versatile disk, a DVD, and/or a raid array, etc. The memory can be coupled to a processor and can store instructions adapted to be executed by processor according to an embodiment disclosed herein.
Network—a wired and/or wireless communication network.
Network interface—a telephone, a cellular phone, a cellular modem, a telephone data modem, a fax modem, a wireless transceiver, an Ethernet card, a cable modem, a digital subscriber line interface, a bridge, a hub, a router, or other similar device.
Patient—a human or other type of animal under supervision for health care purposes.
Patient information—information relevant to the medical care and/or treatment of a patient, including real-time vital, biological, and/or physiological data, near real-time and/or prior history data relating to vital, biological, and/or physiological data, blood pressure parameters, ventilation parameters, vital sign parameters, blood oxygen concentration representative parameters, infusion pump parameters associated with fluid delivery, drip medication related parameters, blood gas parameters, insurance information, health care personnel information, health care organization information, billing information, family information, financial information, therapy information, drug information, and/or any equivalents thereof, etc.
Patient monitoring devices—a device capable of collecting, displaying, and/or relaying patient information.
Processor—a device and/or set of machine-readable instructions for performing a task. A processor comprises any one or combination of hardware, firmware, and/or software. A processor acts upon information by manipulating, analyzing, modifying, converting, transmitting the information for use by an executable procedure and/or an information device, and/or routing the information to an output device. A processor may use the capabilities of a controller.
Server—an information device that provides some service for other information devices connected to it via a network. A common example is a file server, which has a local disk and services requests from remote clients to read and write files on that disk. A server can also provide access to resources, such as programs, shared devices, etc.
Client—an information device and/or process running thereon that requests a service of another information device or process running thereon (a “server”) using some kind of protocol and accepts the server's responses. A client is part of a client-server software architecture. For example, a computer requesting the contents of a file from a file server is a client of the file server.
Thin-client—a relatively simple client program and/or hardware device that relies primarily on a server for most of its capabilities. A Web page displayed using a standard Web browser yet containing either plain text, HTML, scripting, or simple objects (such as ActiveX components or Java Applets) represents an exemplary embodiment of this category.
Uniform resource locator (URL)— a standard way of specifying the location of an object, such as a web page, on the Internet, a network, and/or a server connected thereto. A URL can comprise a data field that comprises one or more identifiers.
User interface—a device and/or program for rendering information to a user and/or requesting information from the user. A user interface can include textual, graphical, audio, video, animation, and/or haptic elements.
User—an individual capable of utilizing a system for accessing patient information.
Vital sign—a measurement of any biological and/or physiological process in a living organism. Exemplary embodiments of vital, biological, and/or physiological data can comprise patient information associated with a patient's heart rate, body temperature, blood gases, red blood cell count, white blood cell status, respiratory volume, respiratory rate, and/or any equivalents thereof.

### DETAILED DESCRIPTION

Certain exemplary embodiments provide a system for accessing patient information in a network. Certain exemplary embodiments of a system for accessing patient information in a network comprise a user interface coupled with processing methods that enable the launching of a thin-client vitals viewer from a clinical access application via a Web-based URL link. Certain exemplary embodiments of the system accept input of a patient identifier and/or user authentication information, such as a user name and password. Input of the patient identifier triggers the system to automatically launch the correct vitals viewer comprising information pertaining to patient associated with an accepted patient identifier from a host server located within a hospital clinical information system. Certain exemplary embodiments of a system for accessing patient information automatically check multiple servers in order to provide patient information to a user. Through the polling of servers, a common database of identifiers for patients and the servers on which their information resides is created and maintained. Through a user interface, the patient information is extracted by utilizing the identifiers to launch a browser-based application such as a vitals viewer.

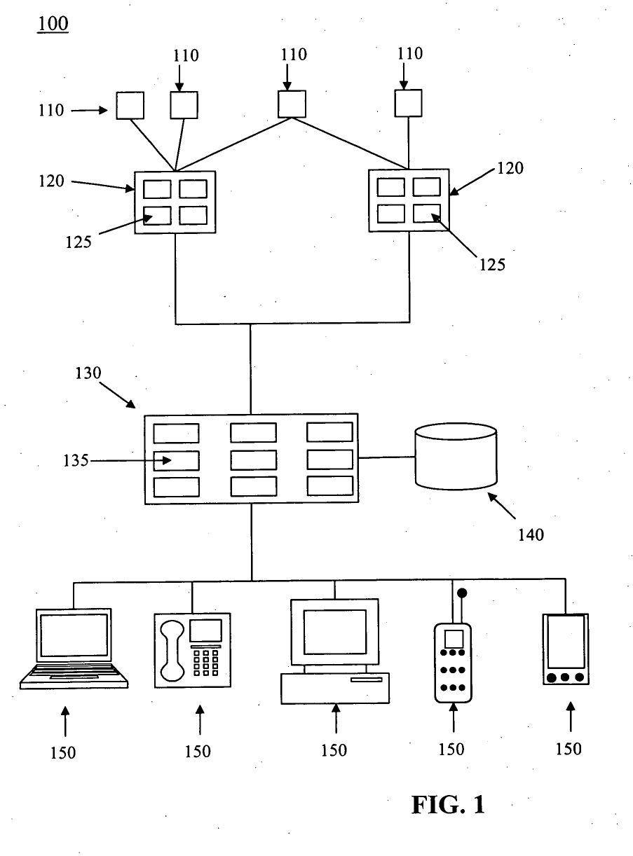

FIG. 1 is an exemplary embodiment of a system 100 for accessing patient information. Certain exemplary embodiments of system 100 comprise a plurality of patient monitoring devices 110. A patient is coupled to one or more patient monitoring devices. Patient monitoring device 110 is coupled to one or more servers 120. Servers 120 comprise one or more processors 125. Processors 125 perform any function, such as gathering information from associated patient monitoring devices 110, organizing collected information according to patient and/or patient monitoring device identifiers, receiving requests for identifiers stored within server 120, sending requested information, performing system maintenance, authorizing a user to access system 100, and/or any equivalents thereof, etc.

In certain exemplary embodiments of system 100, servers 120 are coupled to a repository server 130. Certain exemplary embodiments of repository server 130 comprise a repository 140. Repository 140 comprises the functionality of a database that maintains a combined list of all patients with their respective monitoring devices. An example of a system 100 for accessing patient information utilizes patient identifiers and server identifiers, which are stored in repository 140. Repository server 1130 comprises one or more processors 135. Processors 135 comprise a search processor, an interface processor, an acquisition processor, a display processor, an authorization processor, and/or any equivalents thereof, etc.

Using any appropriate access device 150, a user accesses patient information via repository server 130, repository 140, and/or servers 120. Access device 150 is any general purpose and/or special purpose information device. The network connections of system 100 are wired and/or wireless connections and/or communications network. Certain exemplary embodiments of system 100 are password-protected and/or use standard network security measures, such as password and data encryption, firewalls, virus protection, and/or any equivalents thereof, etc.

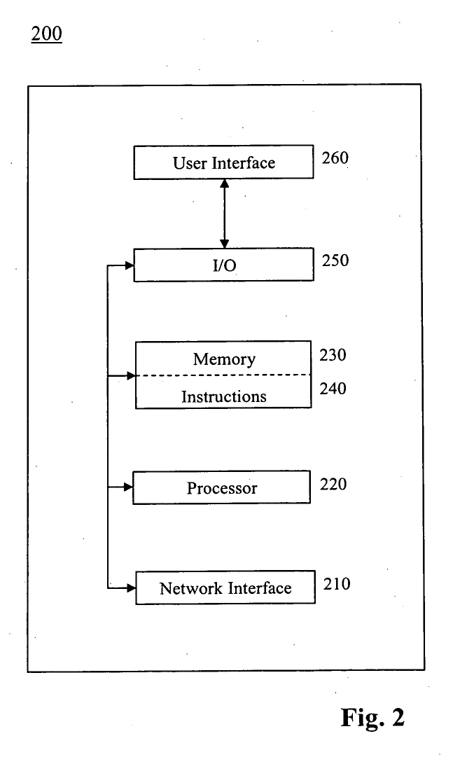

FIG. 2 is a block diagram of an exemplary embodiment of an information device 200, which in certain operative embodiments represents, for example, patient monitoring device 110, server 120, repository server 130, repository 140, and/or access device 150 of FIG. 1. Information device 200 comprises any of numerous well-known components, such as, for example, one or more network interfaces 210, one or more processors 220, one or more memories 230 containing instructions 240, one or more input/output (I/O) devices 250, and/or one or more user interfaces 260 coupled to I/O device 250, etc.

Certain exemplary embodiments of information device 200 include a user interface 260. User interface 260 displays patient information. User interface 260 also presents instructions for interacting with information device 200. In certain exemplary embodiments, user interface 260 functions in concert with one or more input/output (I/O) devices 250. Interaction between user interface 260 and I/O device 250 allows a user to request, collect, organize, view, and/or relay, etc., patient information. Certain exemplary embodiments of I/O device 250 automatically collect, request, relay, display, and/or organize etc., patient information. In certain exemplary embodiments, via one or more user interfaces 260, such as a graphical user interface, a user provides a URL of a patient monitoring device of interest and/or receives current location information concerning the patient monitoring device of interest.

Certain exemplary embodiments of information device 200 comprise patient information that comprises real-time, near real-time, or past patient data collected from other information devices such as patient monitoring devices and their associated servers. In certain exemplary embodiments, patient information is stored within memory 230. Certain exemplary embodiments of memory 230 comprise a list of patient identifiers and their associated server identifiers. Instructions 240 for information device 200 govern the appropriate collection and organization of data and information within memory 230. Instructions 240 are stored on one or more different types of memory.

Certain exemplary embodiments of information device 200 comprise one or more processors 220. An exemplary embodiment of processor 220 is a search processor. In response to a received command, processor 220 initiates a search of memory 230. A received command can be user-initiated, or a timed event scheduled by a user or by software. Processor 220 searches for patient identifiers and server identifiers. Certain exemplary embodiments of processor 220 poll various servers to identify patients connected to patient monitoring devices that are linked to one or more servers. The polling process is an automatic and/or scheduled event. Alternatively, a user commands processor 220 to initiate a search. In certain exemplary embodiments, processor 220 provides notification as to whether a particular patient is currently being monitored before a user attempts to access the patient's medical information. A user need not know the specific location of a particular patient in order to access patient information.

An exemplary embodiment of processor 220 is an interface processor. Thus, certain exemplary embodiments of processor 220 coordinate a response to a user command for patient information. Processor 220 generates a URL address for use in accessing requested information. Certain exemplary embodiments of processor 220 utilize the appropriate patient and server identifiers to generate a URL. When the URL is activated, processor 220 initiates gathering of the requested information. Furthermore, processor 220 communicates the gathered information to a user via user interface 260 and/or I/O device 250. In certain exemplary embodiments, processor 220 determines whether the requested patient identifier and/or associated server identifiers exist within a network and initiate the generation of a message conveying whether the requested identifiers are available. Certain exemplary embodiments of processor 220 inhibit the initiation of a request to access patient medical information if the requested patient identifier and/or a server identifier is absent from the associated network.

An exemplary embodiment of processor 220 is an acquisition processor. Thus, certain exemplary embodiments of processor 220 acquire and/or compile a list of patient identifiers and server identifiers for storage within memory 230. Certain exemplary embodiments of processor 220 collect other forms of data from a plurality of I/O devices 250 and/or user interfaces 260 such as patient vital signs data, patient histories, billing information, and/or any appropriate patient information. In certain exemplary embodiments, the acquisition function of processor 220 is automatic and/or scheduled. Alternatively, a user manually commands processor 220 to perform various tasks. Certain exemplary embodiments of processor 220 periodically and/or aperiodically interrogate a plurality of different servers to compile data indicating patient identifiers and associated server identifiers for storage in said repository. Certain exemplary embodiments of processor 220 periodically and/or aperiodically interrogate a plurality of different servers in response to an input identifying the plurality of different servers. An exemplary embodiment of an input is any data form or record identifying a plurality of identifiers.

An exemplary embodiment of processor 220 is a display processor. Thus, certain exemplary embodiments of processor 220 initiate and/or maintain various forms of displaying data, such as textual and/or graphical data display of patient information on user interface 260, such as an EKG waveform.

An exemplary embodiment of processor 220 is an authorization processor. Thus, certain exemplary embodiments of processor 220 verify that a user is authorized to access patient information stored within one or more information devices 200 and/or a network comprised of a plurality of information devices 200. If a user is not authorized to access patient information, processor 220 prevents access to information device 200 and, in certain exemplary embodiments, processor 220 initiates a message indicating that access is prohibited. Alternatively, if a user is authorized to access information device 200, processor 220 initiates a communication to a user that indicates successful access.

Certain exemplary embodiments of information device 200 comprise a network interface 210. Network interface 210 allows interaction with other information devices 200 via a wired and/or wireless network.

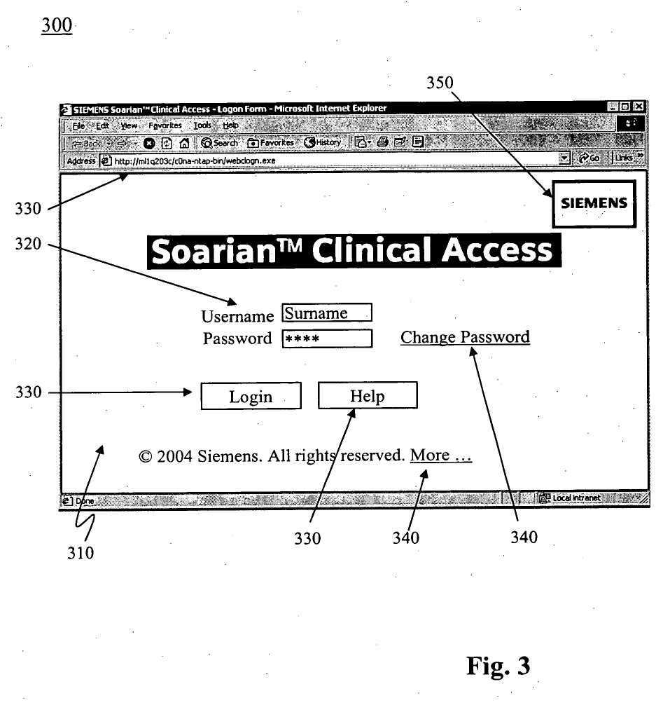

FIG. 3 is an exemplary embodiment of a user interface 300 supporting an operation associated with a system for accessing patient information. Certain exemplary embodiments of user interface 300 are non-browser based executable applications that are configured to gather information through a network. Certain exemplary embodiments of an executable application support access to patient information via a clinical access application that comprises an Internet-compatible user interface 300 and processing methods, thus enabling the launch of a thin-client vitals viewer via a Web-based URL link. Certain exemplary embodiments of user interface 300 are viewed with and/or presented via a browser page identified by a URL address 330. URL address 330 comprises a data field that comprises various identifiers.

Certain exemplary embodiments of user interface 300 comprise a login screen 310. Login screen 310 comprises a login function 320. Certain exemplary embodiments of login function 320 comprise a standard user name and password system. Thus, login function 320 accepts a user's name and password to allow access a system for accessing patient information. Alternatively, login function 320 accepts input of a patient identifier. In certain exemplary embodiments, input of the patient identifier leads to a presentation of the correct vitals viewer from a host server located within a hospital clinical information system.

Certain exemplary embodiments of a login screen 310 comprise one or more user interface elements, such as buttons 330, function links 340, and/or icon links 350. Activation of a user interface element 330, 350 and/or function link 340 causes any action, such as launching a separate window, transferring the user to another window, and/or the launching of a new application, etc.

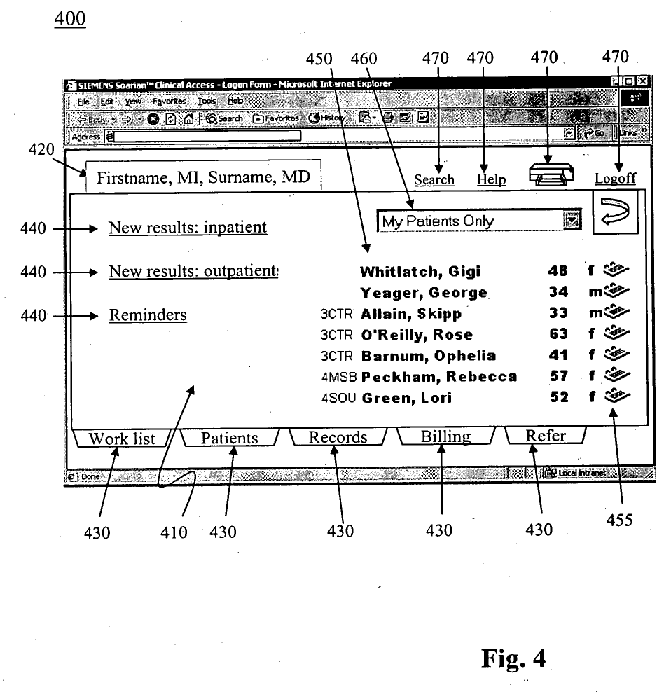

FIG. 4 is an exemplary embodiment of a user interface 400 supporting an operation associated with a system for accessing patient information. User interface 400 presents a patient information view 410. Certain exemplary embodiments of patient information view 410 comprise a patient list 450, one or more function links 440, and/or one or more scroll menus 460. Different screens are selected for viewing via clicking on a page tab 430. Certain exemplary embodiments of summary view 410 comprise a subscreen within user interface 400. Thus certain features of user interface 400 remain static, such as a user identifier 420 and/or various function links 470, such as a print function link icon or a logoff hyperlink.

Certain exemplary embodiments of patient list 450 comprise a list of patient names and associated patient information. Patient information includes name, age, gender, location, and/or vital sign data, etc. Certain exemplary embodiments of a patient name comprise a function link to additional patient information. In certain exemplary embodiments, a patient name is associated with a chart icon 455. In certain exemplary embodiments, user selection of chart icon 455 allows access to any patient information that is found within a traditional patient record.

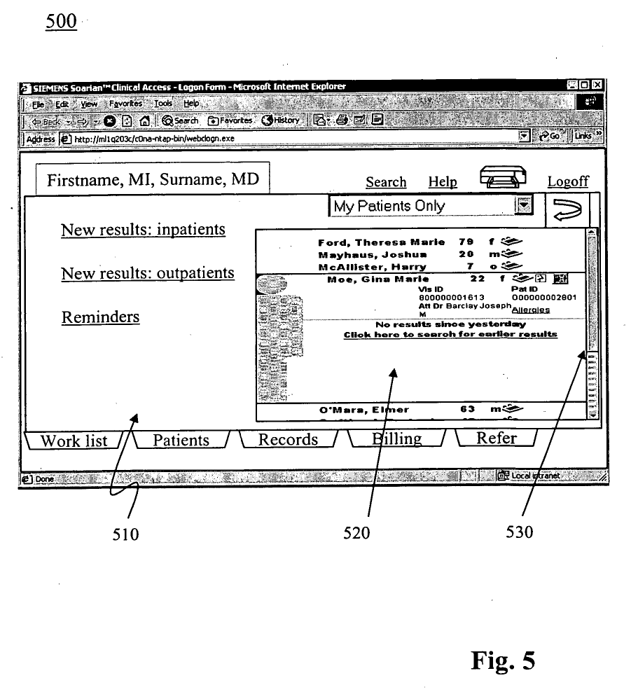

FIG. 5 is an exemplary embodiment of a user interface 500 supporting an operation associated with a system for accessing patient information. User interface 500 comprises a patient information view 510. In certain exemplary embodiments, selection of a patient name launches a detailed patient view 520. Detailed patient view 520 comprises additional patient information, such as ID number, vital signs, physiological data, patient monitoring devices currently attached to the patient, past patient information, and/or any equivalents thereof, etc. Certain exemplary embodiments of detailed patient view 520 also comprise function links to applications for managing patient monitoring devices. For example, a user selects an IV drip icon in order to access a user interface that enables adjustment of the IV drip parameters. Certain exemplary embodiments of detailed patient view 520 comprise various scrolling functions 530 to enable viewing of more data.

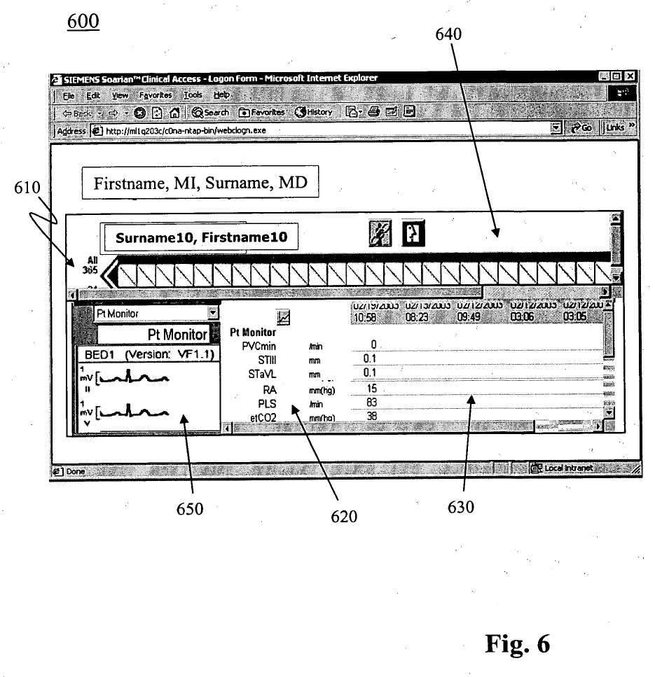

FIG. 6 is an exemplary embodiment of a user interface 600 supporting an operation associated with a system for accessing patient information. Certain exemplary embodiments of user interface 600 comprise a patient vitals viewer 610. Patient vitals viewer 610 comprises any vital sign and/or physiological information 620, 650 for a patient. Patient vitals viewer 610 comprises one or more subscreens 630, 640 that comprise scroll bars. Such an arrangement allows a user to access more information within a single patient vitals viewer 610.

Certain exemplary embodiments of information 620 comprise real-time and/or near real-time physiological information. Information 620, 650 presented within patient vitals viewer 610 is the result of data collected from patient monitoring device and/or data entered by a health care provider at the point of care. Information 620 is represented textually to a user. Certain exemplary embodiments of information 650 comprise graphical information, such as a trace indicating brain electrical activity. Information 620, 650 also comprises previous textual and/or graphical patient data and/or information.

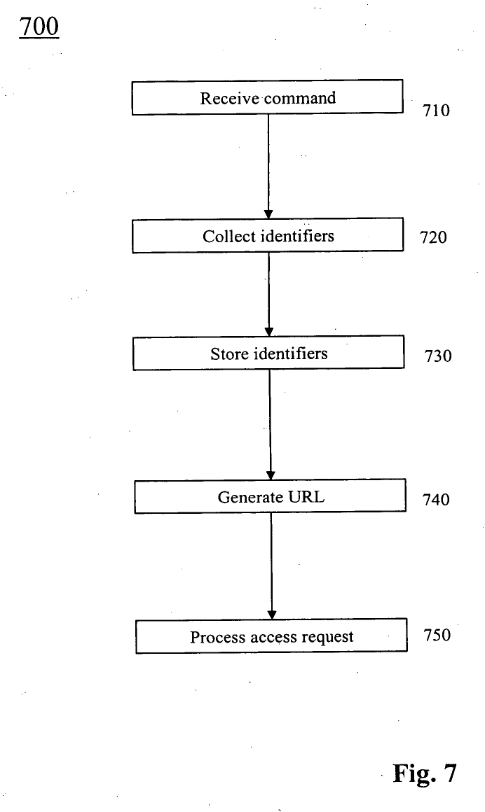

FIG. 7 is a flow chart of an exemplary embodiment of a method 700 for a system for accessing patient information. At activity 710, a command is received. Certain exemplary embodiments of a command comprise instructions for gathering patient identifiers and/or server identifiers associated with particular patients. A command is automatically generated or manually initiated by a user.

At activity 720, the identifiers are collected for storage within a repository. In certain exemplary embodiments, patient identifiers designate a patient who has patient information stored within a patient information management system. The associated server identifiers are used to designate the one or more servers on which a patient's information is stored. At activity 730, identifiers are stored. Identifiers are collected and organized according to any system of organization. In certain exemplary embodiments, a repository server uses a processor, such as an acquisition, search, network, display, authorization, and/or interface processor, to acquire and/or organize patient identifiers and their associated server identifiers. The identifiers are stored within one or more servers and or repositories. In certain exemplary embodiments, a repository comprises a map linking the patient identifiers with their associated server identifiers in order to identify a server hosting medical information for a particular patient. Thus, various polling processes retrieve a list of active patients attached to patient monitoring devices linked to servers, and from this collection a master list and/or map is created. The map is updated continuously and automatically so that changes in any monitored patient parameter are incorporated, thereby eliminating outdated patient information.

At activity 740, a URL is generated. The URL incorporates the patient identifier and/or server identifier within the URL data field. At activity 750, a request to access information is processed. In certain exemplary embodiments, a URL address incorporating a patient identifier and one or more associated server identifiers allows retrieval via a browser of patient information within a network.

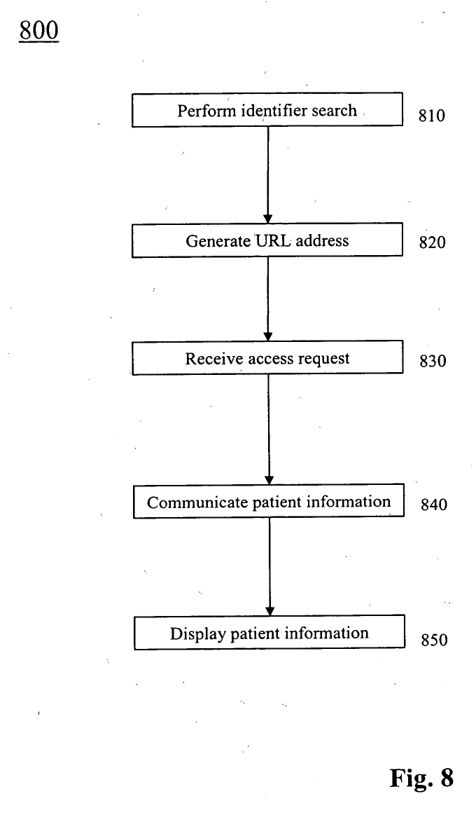

FIG. 8 is a flow chart of an exemplary embodiment of a method 800 for a system for accessing patient information. At activity 810, a search of at least one data source is performed in order to locate a patient identifier and any associated server identifiers. In certain exemplary embodiments, the search is the result of an automatic instruction. Alternatively, a user initiates a search via a command entered through a user interface. At activity 820, a URL address is generated from the search and incorporates a server and/or patient identifier within its data field.

At activity 830, a request to access the patient information at the URL address is received. In certain exemplary embodiments, the request results from a user clicking on a function link. Alternatively, a user enters a user identifier in order to generate a list of patients associated with that user. In certain exemplary embodiments, the user also enters a patient identifier in order to generate a request to access information associated with that particular patient.

At activity 840, the patient information is communicated for display on a user interface. Communication of patient information allows a user to request real-time and/or near real-time patient information. At activity 850, the patient information is displayed to a user via a user interface. In certain exemplary embodiments, if a patient identifier is found with the repository and/or servers, a vitals viewer is launched and presented in a Web page to the user, where the user views the patient information. If the patient identifier is duplicated on multiple servers, the user interface displays this information to the user. If no equivalent patient identifier is found, an appropriate message is displayed to the user. A user does not have to enter a patient location, such as a physical location or a location within the network, in order to access patient information.

Certain exemplary embodiments of a system for accessing patient information comprise a URL call within the clinical client application of: http://<host server_name_or_IP_Address>/WinViewFrontEnd/WvBootAgent.asp. The URL call is physically mapped to the file WVBootAgent.asp within the C:\Inetpub\wwwRoot\WinViewFrontEnd directory on the gateway server.

Certain exemplary embodiments of a system for accessing patient information comprise WVBootAgent.asp. The page is called with the following parameters: http://<host server_name_or_IP_Address>/WinViewFrontEnd/WVBootAgent.asp?Login=guest&PID=xxxxxxxxwvyz&Pwd=winview. The code for this comprises:

```
<%@ Language=VBScript %>
<HTML>
<HEAD>
<META NAME=“GENERATOR” Content=“Microsoft Visual
Studio 6.0”>
</HEAD>
<BODY bgcolor=“black” text=“white” onload=“javascript:close( )”>
<%
    dim urlParameter1
    dim urlParameter2
    dim urlParameter3
    dim urlParameter4
    urlParameter1 = trim(request(“PID”))
    urlParameter2 = trim(request(“Login”))
    urlParameter3 = trim(request(“Pwd”))
    URLValue = “checkPID.asp?PID=”
    URLValue = URLValue & urlParameter1
    URLValue = URLValue & “&Login=” & urlParameter2 & “&Pwd=”
                & urlParameter3
    Response.Write(“<SCRIPT language=‘JavaScript’>”)
    Response.Write(“top.open(‘“ & URLValue &”’)”)
    Response.Write(“</SCRIPT>”)
%>
    <CENTER><h3>WinView Boot Agent</h3></CENTER>
</BODY>
</HTML>
```

Certain exemplary embodiments of a system for accessing patient information can comprise checkPID.asp. Extract PID, Login, and Pwd from the calling page: WVBootAgent.asp. The code for checkPID.asp comprises:

```
<HTML>
<%@ Language=VBScript %>
<BODY>
<%
    dim gatewayAmount
    dim gatewayArray(10)
    dim URLValue
    dim temp
    dim temp2
    dim pidString
    dim urlPID
    dim urlUser
    dim urlLogin
    dim urlPwd
    urlPID = trim(request(“PID”))
    urlLogin = trim(request(“Login”))
urlPwd = trim(request(“Pwd”))
Rem *******************************************************
Rem * Create a file system object for reading and writing.
Rem *******************************************************
    et fs = CreateObject(“Scripting.FileSystemObject”)
Rem *******************************************************
Rem * Define constants for reading, writing, appending data.
Rem *******************************************************
    Const ForReading = 1, ForWriting = 2, ForAppending = 8
Rem *******************************************************
Rem * Compare current PID with List of Pids
Rem *******************************************************
```

Within checkPID.asp, pid_info.inf is a manually-created file that contains a listing of the patient Ids and their associated gateway servers. This file is typically maintained (that is, updated) for each Gateway. The code for checkPID.asp further comprises:

```
Response.Write( “<BR>” )
  set f = fs.OpenTextFile(“C:\SecureFiles\WinViewFE\pid_info.inf”,
ForReading, false )
  IF f.ReadLine = “PID_INFO FILE == DO NOT MODIFY” THEN
    gatewayAmount = 0
    WHILE NOT f.AtEndOfStream
      temp = f.ReadLine
      pos1 = Instr(1,TEMP,“=”,0)
      IF pos1 > 0 THEN
        temp2 = Mid(temp,pos1+1,len(temp))
        temp = Mid(temp,1,pos1)
        pos2 = Instr(1,temp,“\\”,0)
        IF pos2 > 0 THEN
          temp = Mid(temp,pos2+2,len(temp))
        pos3 = Instr(1,temp,“\”,0)
        IF pos3 > 0 THEN
          temp = Mid(temp,1,pos3−1)
        END IF
      END IF
      IF temp2 = urlPID THEN
        gatewayArray(gatewayAmount) = temp
        gatewayAmount = gatewayAmount + 1
      END IF
    END IF
  WEND
END IF
```

In certain exemplary embodiments of checkPID.asp, if only one gateway server is found with this patient ID (PID), then all is well, and the next step is calling the actual ActiveX page that launches the winwebviewer. The code for checkPID.asp further comprises:

```
Rem *******************************************************
Rem * If more than one PID was matched than give a choice
Rem * Otherwise, launch with new PID and Server
Rem *
Rem *******************************************************
IF gatewayAmount = 1 THEN
  URL Value  = “http://” &  gatewayArray(0)  &
“/zeus4panel/index1.htm?Serv=”
  URLValue = URLValue & gatewayArray(0) & “&Login=” & urlLogin
  URLValue = URLValue & “&Pwd=” & urlPwd & “&PatID=” &
  urlPID
  Response.Redirect URLValue
  Response.end
ELSEIF gatewayAmount > 1 THEN
  Response.Write( “<B><FONT FACE=COURIER SIZE=2>PID found
on more than one gateway server<BR>” )
  Response.Write( “Please Choose the gateway Server to
use</FONT></B><BR><BR>” )
For 1=0 to gatewayAmount−1
  Response.Write( “<A href=‘http://” & gatewayArray(0) &
“/zeus4panel/index1.htm?Serv=” & gatewayArray(1) &
    “&Login=” & urlLogin & “&Pwd=” & urlPwd & “&PatID=” &
urlPID &“’> Server: ” & gatewayArray(1) & “</A><BR>” )
Next
ELSE
    Response.Write( “<B><FONT FACE=COURIER SIZE=2>PID
NOT found on any gateway server
    Server</FONT><BR></B>” )
END IF
%>
</BODY>
</HTML>
```

Certain exemplary embodiments of a system for accessing medical information comprise a GatewayPIDListener ReadMe file, which comprises:
WinView Boot Agent
WinViewBootReadMe.txt
   Introduction

Required:
Gateway server(s) creating ptlist.txt
Shared Directory containing ptlist.txt accessible by
GatewayPidListener java application
Webserver (IIS recommended)
WinView Viewer

Recommended:
java sdk (to re-compile if needed, java version 1.4.1 recommended)

Purpose: To allow access to the WinWeb Vitals Viewer from a clinical information access application if a patient vitals are available.

Unzipping

Create a directory called SecureFiles on your C drive.

Unzip WinViewBoot.zip into this directory.

Two directories will be created(WinViewFE and WebRoot)

You will need to make WebRoot available from the webserver either by making it a virtual directory(IIS) or copying it into the web accessible directories.

Note: If you unzip WinViewBoot.zip into any other directory you then typically modify the following lines of code in the following ASP pages:
C:\SecureFiles\WinViewFE\pidinfo.inf->line 35 in checkPID.asp
C:\SecureFiles\WinViewFE\wvpassword.txt->line 29 in ProcessPassword.asp

Edit these to contain the appropriate path to these two files.

Setup

GateWayList.txt

This file is located in the WinViewFE directory. You modify this file with the correct locations of the ptlist.txt files on each Gateway server you wish to poll. ptlist.txt is accessible from a network drive for our java application to have access.

Do not edit the first line:

Use the following format for the ptlist.txt location:
\\[ip address/server name]\[name of directory containing ptlist.txt]\ptlist.txt

For example:
\\Gateway1\vs files\ptlist.txt

wvpassword.txt

This file is located in the WinViewFE directory. You modify this file with the proper username and passwords you wish to use with the WvLogin.asp page.

This file contains username and password in the following format:
[username] [password]

For example:
MyName MyPassword
(NOTE: at the moment, the name does not contain any spaces)
   Using the WinViewBoot Agent
   From a clinical information access application

WvBootAgent.asp is accessible from a webserver.

The link to WVBootAgent.asp from clinical information access application contains the following parameters when called: PID, USER

Additional note: will also operate with other clinical information access applications.

The PID will contain the PID of the patient attempting to be viewed

The USER will contain the Username that will be used to access the viewer.

From the server that contains the GatewayPidListener java application

To run the GatewayPidListener, make sure that GateWayList.txt is in the same directory as the GatewayListener.bat file and the GatewayListener.class file. (NOTE: These should all be located in the WinViewFE directory)

Execute the GatewayListener.bat file, this will launch the java application and the application will poll the specified gateway servers

Certain exemplary embodiments of a system for accessing medical information comprise GatewayPIDListenerjava. The code comprises:

```
import java.io.*;
import java.awt.*;
import java.net.*;
import java.lang.*;
import java.util.*;
import java.lang.Math;
import java.util.Random;
import java.text.*;
import java.util.Vector;
  public class GatewayPidListener extends Thread implements Runnable
  {
    private String ListFileName = “GateWayList.txt”; //location and filename
  of GateWayList.txt
    private String outputFileName = “pid_info.inf”; //location and filename of
  Output file
    private int PollDelay = 30; //Delay of Poll in Seconds
    boolean keepRunning = true; //true to continuously run in seconds
    boolean debug = false; //debug output
  Vector serverArray = new Vector( ); //Holds all gateway servers
  private int serverAmount = 0;
  File ListFile = new File( ListFileName );
  File outputFile = new File( outputFileName );
  public GatewayPidListener( )
  {
    this.start( );
  }//End Constructor
  public void run( )
  {
    System.out.println(“Polling gateway servers.....”);
    do
    {
      ListGrabber( );
      CreateOutput( );
//Reset all data
      serverArray.removeAllElements( );
      serverAmount = 0;
      System.out.print(“>”);
      try //sleep for amount
      {
        sleep( PollDelay * 1000 );
      } catch ( InterruptedException ie ) {
        System.err.println( “Problem with the sleep thread: ” + ie );
    } // end catch
    }while(keepRunning); //loop while keepRunning
  }
  public static void main( String argv[] )
  {
    GatewayPidListener MV = new GatewayPidListener( );
  }//End main
public boolean ListGrabber( )
  {
  try
  {
  BufferedReader listInput = new BufferedReader(new FileReader( ListFile ));
  String dummy = listInput.readLine( ); //System.out.println( dummy );
  if (dummy.equals(“*** GateWay List Path ***”))
  {
  int counter = 0;
  while ((dummy = listInput.readLine( )) != null )
  {
    if(debug)
        System.out.println(“ADDED to serverARRAY[“+serverAmount+”]:
    ”+dummy);
      serverArray.addElement(dummy);
      serverAmount++;
      }//END while
      }//END if dummy
    } catch ( Exception e) {
    System.err.println( “Error in loadList( ): ” + e);
    return false;
    }
  return true;
}//END ListGrabber
public void CreateOutput( )
    {
        try
        {
        PrintWriter FOut = new PrintWriter( new FileWriter(outputFile));
        FOut.println(“PID_INFO FILE == DO NOT MODIFY”);
        //Open Each ptlist.txt to determine PIDS
        for(int i=0;i<serverAmount;i++)
        {
          try
          {
            File temp = new File((String)serverArray.elementAt(i));
            BufferedReader Fin = new BufferedReader(new
    FileReader( temp ));
            String dummy;
            for(int j=0;j<9;j++) //SKIP to pids
              dummy = Fin.readLine( );
            while ((dummy = Fin.readLine( )) != null )
            {
              if(!dummy.equals (“[End List]”))
              {
              if(debug)
              System.out.println(dummy);
  //parse out pid
            int pos1 = 0;int pos2 = 0;
            String thepid = “”;
            pos1 = dummy.indexOf(“|”);
            if(pos1 >= 0)
              thepid =
      dummy.substring(pos1+1,dummy.length( ));
              pos2 = thepid.indexOf(“|”);
              if(pos2 >= 0)
              thepid = thepid.substring(0,pos2);
              if(debug)
              System.out.println(“PID: ”+thepid);
              //output to file
        FOut.println((String)serverArray.elementAt(i)+“=”+thepid);
          }//end if !dummy
        }//end while
      } catch (Exception e) {
      System.err.println( “Error in read ptlist: ” + e);
    }
  }//End for i
  FOut.close( );
  } catch (Exception e) {
  System.err.println( “Could not open the output file for writing: ” + e);
  } // End catch
  }//End ExamineList
  }//END GatewayPidListener
```

Certain exemplary embodiments of a system for accessing patient information comprise the following instructions for locating a server:

```
C:
  Inetpub
    wwwRoot
      WinViewFrontEnd
        WVBootAgent.asp
        checkPID.asp
C:
  SecureFiles
    WinViewFE
        GatewayList.txt
        pid_info.inf
        GatewayPidListener.bat
        GatewayPidListener.java
        GatewayPidListener.class
```

Certain exemplary embodiments of a system for accessing patient information comprise an automated launching of GatewayPidListener on a Gateway server. Locate GatewayPidListener_auto.bat on the C: drive of one Gateway. The contents of this file:
cd c:\securefiles\winviewfe
GatewayPidListener.bat

Then enter the following information into the Autoexec.bat file on the server (accessed using Sysedit command from the Start->Run command line):
c:\GatewayPidListener_auto.bat

If for some reason a process is not running as verified by inspecting processes within a task management operation, then a user accesses either the GatewayPidListener_auto.bat file within the c: drive or the GatewayPidListener.bat file within securefiles\winviewfe. This may also be accomplished by placing the GatewayPidListener_auto.bat file within the Startup file folder. This causes the process to launch automatically upon server boot.

Certain exemplary embodiments of a system for accessing patient information comprise a user interface and processing methods that enable the launching of a thin-client vitals viewer from a Clinical Access application via a Web-based URL link. This system accepts patient ID and automatically launches the correct vitals viewer from the host gateway server located within a hospital clinical information system and presents the results of this patient (if on a monitor) through the Web launched through its own Web window. While the vitals viewer itself accomplishes this on its own without assistance, the system has the ability to check multiple existing servers automatically (without the need to specify via a Clinical Access application) to provide a correct patient's vital waveforms to the user. The system of methods that accomplish this involve polling processes that retrieve a list of active patients on vitals monitors on each existing server, and create a master list which is retrieved by the Web-based viewer for near-real-time determination as to whether a patient is on a vitals monitor. If a patient is found within the server's associated databases, the patient's vitals viewer is launched and presented in a Web page to the user, where the user views the near-real-time vitals results. If patient ID is duplicated on multiple servers, such a method is displayed to the user. If no equivalent patient identifier is found, this message is displayed to the user.

The current suite of server products provides a thin-client Web viewer for patient vitals data. In order to display a particular patient's vital parameters via thin-client Web viewer it is necessary to specify the user ID, user password, name of the particular server on which patient resides, and patient identifier. However, knowledge of the particular server is typically not available to a health information system user as this information is normally maintained within the clinical environment at the point of care. A system for accessing patient information removes the need for the user to know and specify the particular Gateway server by maintaining a common database of all Gateway patient list files (normally written by the servers) and using these in combination with a launching page to extract the identity of the Gateway server and the associated patients on the server(s).

A system for accessing patient information advantageously provides the ability to launch the thin-client Web-based vitals viewer supplied with the gateway server suite of products without having to specify beforehand the location of a patient on a particular gateway server. In an alternative exemplary embodiment, a particular server identifier is encoded into a URL call to the thin-client Web viewer. The system is usable by other applications that require specific knowledge of a location of an entity within an enterprise (that is, locating a particular patient within the clinical domains of a particular hospital).

Still other embodiments will become readily apparent to those skilled in this art from reading the above-recited detailed description and drawings of certain exemplary embodiments.

1. A system for accessing patient medical information in a network including a plurality of servers, comprising:
a repository comprising patient identifiers and associated server identifiers for use in identifying a particular server storing medical information of a particular patient;
a search processor for initiating, in response to a received command, a search of said repository to locate a particular server identifier associated with an identifier of said particular patient; and
an interface processor for generating a URL address incorporating said located particular server identifier in a data field and for initiating, in response to a user command, a request to access said stored medical information of a particular patient at said generated URL address hosted by said particular server.

2. A system according to claim 1, wherein
said repository comprises a map linking said patient identifiers and said associated server identifiers for identifying a server hosting medical information of a particular patient.

3. A system according to claim 1, wherein
said interface processor generates said URL address by incorporating said particular patient identifier in a data field.

4. A system according to claim 1, wherein
said search processor determines at least one of: (a) whether said repository contains a plurality of said particular patient identifiers and (b) whether said repository contains no identifiers matching said particular server identifiers; and
said interface processor initiates generation of a message identifying at least one of (a) and (b) in response to said determination.

5. A system according to claim 4, wherein
said interface processor inhibits initiating a request to access said stored medical information of said particular patient in response to a determination of at least one of (a) and (b).

6. A system according to claim 1, further comprising
an acquisition processor for interrogating a plurality of different servers to compile data indicating patient identifiers and associated server identifiers for storage in said repository.

7. A system according to claim 6, wherein
said acquisition processor periodically interrogates said plurality of different servers in response to a record identifying said plurality of different servers.

8. A system according to claim 1, further comprising
a display processor for initiating generation of data representing said accessed stored medical information of said particular patient.

9. A system according to claim 1, wherein
said accessed stored medical information of said particular patient comprises at least one of (a) a blood pressure parameter, (b) a ventilation parameter, (c) a vital sign parameter, (d) a blood oxygen concentration representative parameter, (e) an infusion pump parameter associated with fluid delivery, (f) a drip medication related parameter, (g) blood gas parameters, and (h) financial information concerning an interaction of said particular patient with a healthcare organization.

10. A system according to claim 1, further comprising
an authorization processor for verifying that a user is authorized to access said stored medical information of said particular patient in response to said user command and for inhibiting access of said user to said stored medical information of said particular patient in response to an unsuccessful verification.

11. A system for accessing patient medical information in an Internet Protocol compatible network including a plurality of servers, comprising:
an executable application supporting access to patient medical information via an Internet-compatible user interface;
a search processor for initiating, in response to a user command entered using said user interface, a search of at least one data source to find a particular server identifier associated with an identifier of a particular patient; and
an interface processor, for:
generating a URL address incorporating said particular server identifier, found by said search processor, in a data field
initiating a request to access, via said generated URL address, said stored medical information of said particular patient hosted by said particular server; and
communicating said accessed stored medical information for display to a user using said Internet-compatible user interface.

12. A system according to claim 11, wherein
said at least one data source comprises at least one of (a) a repository including patient identifiers and associated server identifiers for use in identifying a particular server storing medical information of a particular patient and (b) a plurality of different servers.

13. A system for accessing patient medical information in an Internet Protocol compatible network including a plurality of servers, comprising:
an executable application supporting access to patient medical information via an Internet compatible user interface;
a repository including patient identifiers and associated server identifiers for use in identifying a particular server storing medical information of a particular patient;
a search processor for initiating, in response to a received command, a search of said repository to locate a particular server identifier associated with an identifier of said particular patient; and
an interface processor for initiating, in response to a user command, a request to access said stored medical information of a particular patient at a URL address derived in response to said located particular server identifier and said particular patient identifier.

14. A system according to claim 13, further comprising
an acquisition processor for interrogating a plurality of different servers to compile data indicating patient identifiers and associated server identifiers for storage in said repository.

15. A system according to claim 14, wherein
said acquisition processor periodically interrogates said plurality of different servers in response to a record identifying said plurality of different servers.

16. A method for accessing patient medical information in a network including a plurality of servers, comprising the activities of:
storing patient identifiers and associated server identifiers for use in identifying a particular server storing medical information of a particular patient;
initiating a search to locate a particular server identifier associated with an identifier of said particular patient, in response to a received command;
generating a URL address incorporating said located particular server identifier in a data field; and
initiating a request to access said stored medical information of a particular patient at said generated URL address hosted by said particular server, in response to a user command.

17. A method for accessing patient medical information in an Internet Protocol compatible network including a plurality of servers, comprising the activities of:
initiating a search of at least one data source to find a particular server identifier associated with an identifier of a particular patient, in response to a user command entered using a user interface;
generating a URL address incorporating in a URL data field said particular server identifier found by said search;
initiating a request to access stored medical information of the particular patient at said generated URL address hosted by said particular server; and
via the Internet Protocol compatible network, communicating said accessed stored medical information for display to the user interface.

18. A method for accessing patient medical information in an Internet Protocol compatible network including a plurality of servers, comprising the steps of:
storing patient identifiers and associated server identifiers for use in identifying a particular server storing medical information of a particular patient;
in response to a received command, initiating a search to locate a particular server identifier associated with an identifier of said particular patient; and
in response to a user command, initiating a request to access said stored medical information of the particular patient at a URL address derived from the located particular server identifier and said particular patient identifier.
